(19) United States
(12) Patent Application Publication
(10) Pub. No.: US 2008/0215460 A1
(43) Pub. Date: Sep. 4, 2008

(54) Merchandise location system

(76) Inventor: Michael T. McKibben, Columbus, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/012,219

(22) Filed: Jan. 31, 2008

Related U.S. Application Data
(60) Provisional application No. 60/887,473, filed on Jan. 31, 2007.

(51) Int. Cl. G06Q 10/00; G06Q 30/00; G06F 17/30; G06F 17/40

(52) U.S. Cl. 705/28; 701/301

(57) ABSTRACT

The present invention is generally directed to providing an improved system for accessing merchandise location information in a sales environment. Specifically, the present invention implements a system to record, store, and make available for remote access by authorized users merchandise location information within a sales environment.

### CROSS-REFERENCE TO RELATED APPLICATIONS

This application claims the benefit of U.S. Provisional Application Ser. No. 60/887,473, entitled “MERCHANDISE VIEWING ARCHITECTURE,” filed on Jan. 31, 2007, the disclosure of which is incorporated herein by reference.

### FIELD OF THE INVENTION

The present invention is generally directed to providing an improved system for accessing merchandise location information in a sales environment. Specifically, the present invention implements a system to record, store, and make available for remote access by authorized users merchandise location information within a sales environment.

### BACKGROUND OF THE INVENTION

Currently, there is a no easy solution for tracking the location of merchandise in a sales environment by a third party vendor. For example, it is extremely difficult for a peanut butter manufacturer to know where in a grocery store their peanut butter is located. Even if the peanut butter manufacturer has an agreement in place with the grocery store to display the peanut butter at the end of an aisle, the peanut butter manufacturer cannot easily determine if the grocery store is complying with such an agreement. Without physically traveling to the grocery store, the peanut butter manufacturer has no adequate means to confirm that the grocery store is complying with a prearranged agreement. The problem becomes much worse if the grocery store is a chain of grocery stores with 1,000 stores nationwide. Therefore, there is a need for a system that allows users (e.g. vendors) to view merchandise location information at a remote location.

### SUMMARY OF THE INVENTION

Aspects of the present invention address this need by providing an improved system for accessing merchandise location information in a sales environment.

It is a first aspect of the present invention to provide a computer-implemented merchandise location system that includes a location recording device for recording merchandise location information within a sales environment, a location database adapted to store merchandise location information, a data input device for creating a database record in the location database, an output device adapted to output the database record, and a data management tool adapted to receive a request from an authorized user and, in response to the request, transmit the database record to the output device. The data management tool allows the authorized user to perform data operations on the database record and further allows more than one authorized user simultaneous access to the database record.

In one embodiment of the first aspect, the merchandise location information includes an aisle number, shelf description, location coordinates, cardinal direction, ordinal direction and/or location description. In another embodiment, the location recording device includes a camera, a video recorder, an audio recorder and/or a data capture system. In another embodiment, the location recording device is operated by a sales environment employee, a sales environment contractor, and/or a sales environment customer.

In another embodiment of the first aspect, the merchandise location information includes text, video, audio, an image and/or a photograph. In yet another embodiment, the sales environment includes a grocery store, an apparel store, a home furnishings store, a gas station and/or a general store.

In another embodiment, the data input device is further adapted to update an existing database record in the location database. In yet another embodiment, the output device includes a computing device, a portable computing device, a printing device, a cellular telephone, a personal digital assistant, a smartphone and/or a portable wireless device.

In yet another embodiment, the data management tool is a software application. The software tool may operate on a network computing device. The data management tool may be accessible via a network portal, an intranet and/or the Internet.

In another embodiment, the data operations include viewing, editing, copying, moving, transmitting and/or deleting the database record. In one embodiment, the location database may be located within the sales environment. The location database may be located on a network outside of the sales environment in one embodiment. The merchandise location information may be accessible in real-time.

In another embodiment of the first aspect, the system further includes a mapping component for mapping merchandise location information in an Enterprise Resource Planning system. In still yet another embodiment, the system further includes a compliance mechanism adapted to review the merchandise location information and notify the user when the merchandise location information is not in accordance with a predetermined agreement. In another embodiment, the compliance mechanism is further adapted to generate a compliance report at a predetermined time interval.

In another embodiment, the merchandise location information is determined, at least in part, using at least one of a barcode technology, a Radio Frequency Identification technology and a triangulation technology.

In another embodiment the data management tool associates merchandise location information with merchandise sales information within the sales environment. The merchandise sales information may be located in a third party vendor database.

From the foregoing disclosure and the following detailed description of various preferred embodiments it will be apparent to those skilled in the art that the present invention provides a significant advance in the art of location systems. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a schematic diagram of a merchandise location system in accordance with one embodiment of the present invention;

FIG. 2 is a schematic diagram of an alternate embodiment of the merchandise location system of FIG. 1; and

FIG. 3 is an exemplary computer screenshot depicting an implementation of the merchandise location system in accordance with one embodiment of the present invention.

### DETAILED DESCRIPTION

It will be apparent to those skilled in the art that many uses and variations are possible for the system of the present invention. The following detailed discussion of various exemplary embodiments will illustrate the general principles of the invention. Other embodiments will be apparent to those skilled in the art given the benefit of this disclosure.

It should be noted that, as used herein, a sales environment may include any type or store or location where merchandise is sold such as, without limitation, a grocery store, an apparel store, a home furnishings store, a gas station and a general store.

The disclosed system provides the capability to view merchandise location information on store shelves, aisle endcaps, or kiosks from a remote location. In one embodiment, the system facilitates the monitoring of the placement of merchandise of vendors for store compliance in accordance with contracts and other types of agreements. Specifically, product vendors contract with retailers for shelf space for the presentation of vendor merchandise (e.g., foods, clothing, etc.). Vendors may pay different rates, for example, based on the location of their products in the store (e.g., on the aisle, shelf, endcap, etc.). Higher rates may be charged for locations that experience higher customer traffic or exposure. Accordingly, after contracting for product placement, compliance needs to be enforced.

One embodiment provides a way to view, remotely, the current placement of contracted merchandise in a store or any sales location in which such agreements exist. Once merchandise location information, in the format of text, image, video and audio, for example, is recorded, the data is made available to a system (e.g. an Internet-capable computer) for access by authorized individuals.

One embodiment of the present invention includes a centrally-accessible network system that can provide access to data of a large number of stores. For example, a vendor can login and select presentation data from any number of stores with which the vendor has contracted for shelf space to visualize that the store has placed vendor products according to the contract.

Data input to the system can be from a person who walks through the store with a recording device (e.g., camera for video and/or still image data, audio recorder for audio input) and thereafter transmits the data for presentation to the vendor. Alternatively, data can be received from store surveillance systems, for example, that can capture the desired location(s) and upload the captured data to the system for vendor viewing. In yet another embodiment, given that products typically have a form of electronically readable indicia (e.g., bar code, RFID tag), the location of products and/or merchandise may be verified by the scanning of such tags by store systems, a vendor compliance employee or contractor who provides this information as part of compliance measures, a store employee, and/or even a customer who may be provided with an automated electronic store device (e.g., handheld scanner) for shopping in the store.

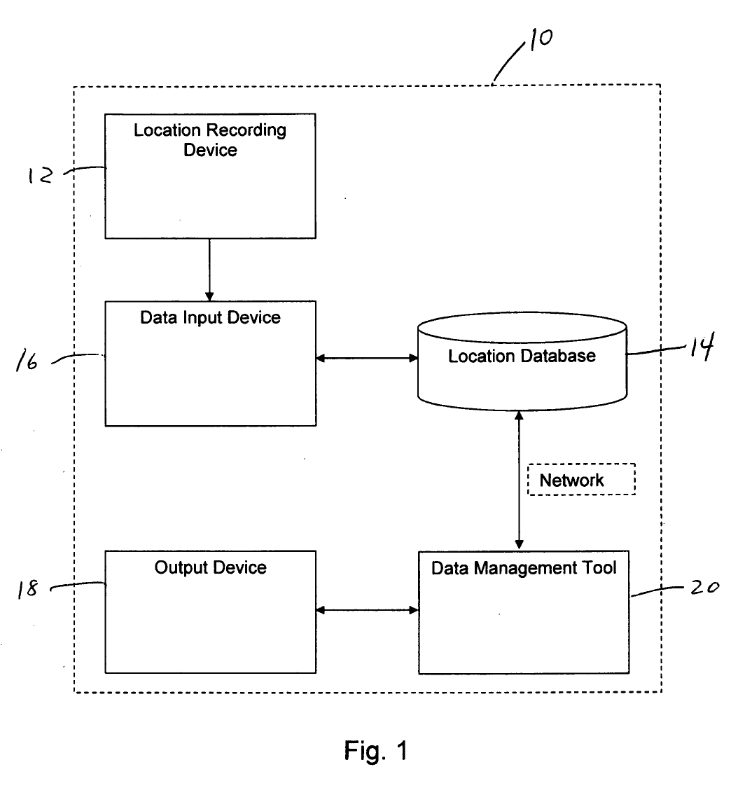

FIG. 1. depicts one embodiment of the present invention. In this embodiment, the merchandise location system 10 includes a location recording device 12, a location database 14, a data input device 16, an output device 18, and a data management tool 20. The location recording device 12 records merchandise location information within a sales environment. The location database 14 stores merchandise location information. The data input device 16 creates at least one database record in the location database 14. The output device 18 outputs the at least one database record. The data management tool 20 receives requests from authorized users and, in response to the requests, transmits the at least one database record to the output device 18.

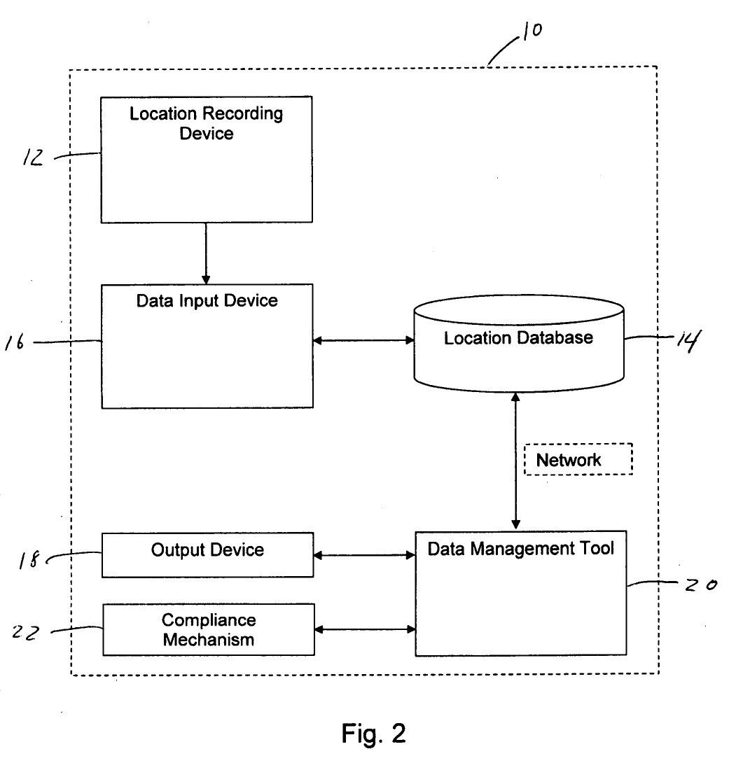

In one embodiment, as shown in FIG. 2, the system 10 also includes a compliance mechanism 22 for notifying the user when the merchandise is or is not located and/or presented in accordance with a prearranged agreement. The compliance mechanism 22 can automatically generate a compliance report for the user on a periodic basis or at prearranged time intervals (e.g. daily, weekly, monthly, annually).

In one embodiment, the present invention is a computer-implemented merchandise location system 10 that includes a location recording device 12 for recording merchandise location information within a sales environment, a location database 14 for store merchandise location information, and a data input device 16 for creating at least one database record in the location database 14. The system also includes an output device 18 adapted to output the at least one database record and a data management tool 20 adapted to receive a request from an authorized user and, in response to the request, transmit the at least one database record to the output device 18. The data management tool 20 allows the authorized user to perform data operations on the at least one database record and also allows more than one authorized user simultaneous access to the at least one database record.

Merchandise location information may include any type of location identifying information. In one embodiment, this may include an aisle number, a shelf description, location coordinates, cardinal direction, ordinal direction and/or a location description. Also, the merchandise location information may be in any textual, visual, audible or any other format capable of expressing location information. In one embodiment, this may include text, video, audio, images and/or photographs. In one embodiment, the merchandise location information is available for access in real-time, while other embodiments may make merchandise location information only on a periodic basis. This periodic basis may include hourly, daily, weekly, monthly, annually time intervals, for example.

The location recording device 12 for recording merchandise location information within a sales environment may include any type or manner of location recording devices. One embodiment provides that the location recording device 12 may include a camera, a video recorder, an audio recorder and/or a data capture system. A data capture system may be a store surveillance system, portable scanning device or any other system capable of recording location information. In one embodiment, the merchandise location information may be determined, at least in part, by using a barcode technology, a Radio Frequency Identification technology and/or a triangulation technology. The location recording device 12 may be operated by a sales environment employee, a sales environment contractor, a sales environment customer, and/or no human operator at all.

During or after the recording of merchandise location information, the merchandise location information is stored in a location database 14. The location database 14 may include any database capable of storing a plurality of data records for subsequent retrieval. Any known database implementation may be utilized. This includes any database implementation on a computing device and/or a server device. In one embodiment, the location database 14 is located within the sales environment. In another embodiment, the location database 14 is located on a network outside of the sales environment.

The data input device 16 of the system allows for the creation of one or more database records in the location database 14. In one embodiment, the data input device 16 is further adapted to update an existing database record in the location database 14. It should be noted that the location recording device 12 and the data input device 16 may be located within the same device. For example, a camera may have the ability to produce a photograph of the location of merchandise and also create a database record including the photograph by transmitting the photograph to the location transmitting.

The system 10 also includes an output device 18 adapted to output the database records. The output device 18 may include a computing device, a portable computing device, a printing device, a cellular telephone, a personal digital assistant, a smartphone and/or a portable wireless device. Any device capable of displaying, printing, or otherwise outputting database records may be implemented in the system 10.

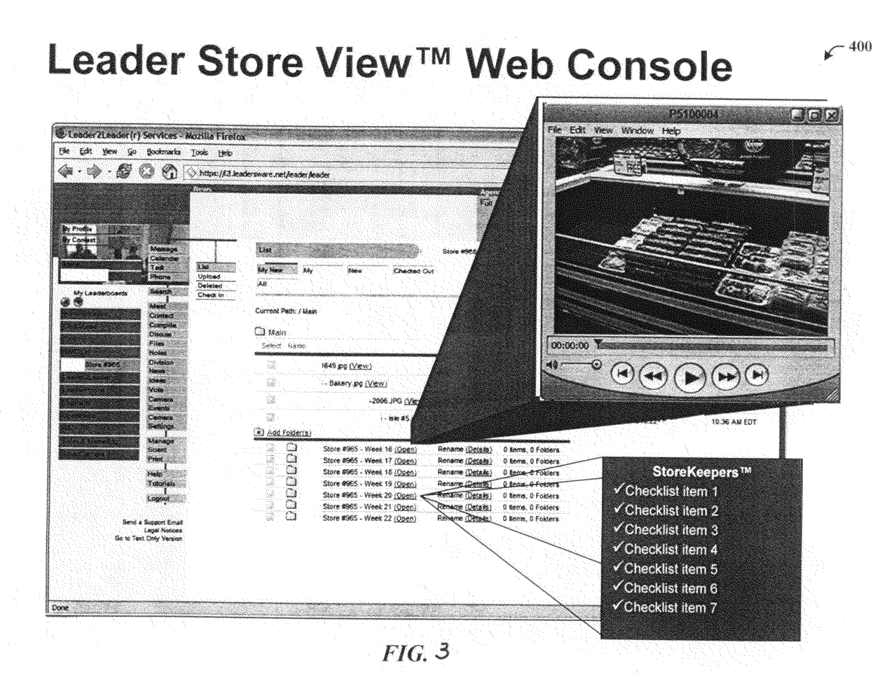

The data management tool 20 in one embodiment is adapted to receive a request from an authorized user and, in response to the request, transmit the at least one database record to the output device 18. FIG. 3 depicts one embodiment of the data management tool 20 as displayed on an output device 18 (computer web browser). The data management tool 20 allows the authorized user to perform data operations on a database record and also allows more than one authorized user simultaneous access to the at least one database record. In one embodiment, the data management tool 20 is a software application. This software application may operate on a computing device. The data management tool 20 may accessible via a network portal, an intranet, the Internet, or through any other communication channel. The data operations may include viewing, editing, copying, moving, transmitting and deleting the database record, or any other access or manipulation of the database record. One embodiment further includes a mapping component for mapping merchandise location information in an Enterprise Resource Planning system.

In one embodiment of the present invention, the data management tool 20 may be of the type as disclosed in U.S. patent application Ser. No. 10/732,744, the entire disclosure of which is incorporated herein by reference. This data management tool 20 is a unified, horizontal system for communications, organization, information processing, and data storage. The tool 20 installs on existing platforms, and is a common workflow layer that is automated with a scalable, relational database. The tool 20 includes a relational database engine that facilitates many-to-many relationships among data elements, in addition to, one-to-many and many-to-many relationships.

The data management tool 20 in this embodiment includes an architecture where the highest contextual assumption is that there exists an entity that consists of one or more users. The data storage model first assumes that files are associated with the user. Thus, data generated by applications is associated with an individual, group of individuals, and topical content, and not simply with a folder, as in traditional systems.

When a user logs in to the system that employs the tool 20, the user enters into a personal workspace environment. This workspace may be called a board, and is associated with a user context. From within this board, the tool 20 makes accessible to the user a suite of applications for creating and manipulating data. Any user operating within any board has access to the suite of applications associated with that board, and can obtain access to any data in any form (e.g., documents and files) created by the applications and to which he or she has permission. Moreover, thereafter, the user can then move to shared workspaces (or boards), and access the same data or other data.

Data created within the board is immediately associated with the user, the user's permission level, the current workspace, any other desired workspace that the user designates, and the application. This association is captured in a form of metadata and tagged to the data being created. The metadata automatically captures the context in which the data was created as the data is being created. Additionally, the data content may be indexed to facilitate searching for the content in a number of different ways in the future by the user or other users. This tagging process is universal, in that, the data model allows for any binary data (e.g., files), as well as any set of definable data to be accepted into the system. The system is not restricted to processing e-mail, faxes, calendar events, meetings, phone calls, etc., that are included in the bundled system, but can also accommodate whatever data the user chooses to use. The system is also universal insofar as its user interaction can be through a browser that is pervasively employed for use with conventional operating systems.

In that the tool 20 supports multiple users, there can be multiple boards. Two or more boards (or workspace environments) can be grouped as a collection of boards, also called a web. Boards can exist in any number of different webs. The association of webs and boards is stored in a table. As a user creates a context, or moves from one context to at least one other context, the data created and applications used previously by the user automatically follows the user to the next context. The change in user context is captured dynamically. All files and groups of files can be associated with any other file in the system, allowing a system user the flexibility in determining dynamic associations.

In one embodiment, the data management tool 20 associates merchandise location information with merchandise sales information within the sales environment. Merchandise sales information may be any information related to the sales of a product. This may include, without limitation, quantity sold, quantity remaining, suggested price and sale price. This sales information may be located within the sales environment or in a third party vendor database.

One embodiment further includes a compliance mechanism 22 adapted to review the merchandise location information and notify the user when the merchandise location information is or is not in accordance with a predetermined agreement. This mechanism may be manually-implemented or computer-implemented. Upon reviewing the merchandise location information, a determination is made of whether the merchandise location information complies with a prearranged agreement or contract. If the merchandise location information is in accordance with the agreement, no notice to the user is sent to the user. In another embodiment, a notice may be sent to the user to communicate that the merchandise location information is in accordance with the agreement. Such notices may be in textual form (such as an email or letter) or an audible format (such as a voice alert or a telephone call or message).

In another embodiment, the compliance mechanism 22 is further adapted to generate a compliance report at a predetermined time interval. Such a compliance report may be generated at any predetermined time interval as defined by the user and/or the sales environment. For example, the user may wish to generate and receive a monthly compliance report and the sales environment may wish to generate a weekly compliance report. Any time interval may be implemented.

Following from the above description and invention summaries, it should be apparent to persons of ordinary skill in the art that, while the systems herein described constitute exemplary embodiments of the present invention, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the identified advantages or objects of the invention disclosed herein in order to fall within the scope of the claims, since inherent and/or unforeseen advantages of the present invention may exist even though they may not have been explicitly discussed herein.

What is claimed is:

1. A computer-implemented merchandise location system, comprising:
a location recording device for recording merchandise location information within a sales environment;
a location database adapted to store merchandise location information;
a data input device for creating at least one database record in the location database;
an output device adapted to output the at least one database record; and
a data management tool adapted to receive a request from an authorized user and, in response to the request, transmit the at least one database record to the output device;
wherein the data management tool allows the authorized user to perform data operations on the at least one database record;
and wherein the data management tool allows more than one authorized user simultaneous access to the at least one database record.

2. The system of claim 1, wherein the merchandise location information includes at least one of aisle number, shelf description, location coordinates, cardinal direction, ordinal direction and location description.

3. The system of claim 1, wherein the location recording device includes at least one of a camera, a video recorder, an audio recorder and a data capture system.

4. The system of claim 1, wherein the location recording device is operated by at least one of a sales environment employee, a sales environment contractor, and a sales environment customer.

5. The system of claim 1, wherein the merchandise location information includes at least one of text, video, audio, an image and a photograph.

6. The system of claim 1, wherein the sales environment includes at least one of a grocery store, an apparel store, a home furnishings store, a gas station and a general store.

7. The system of claim 1, wherein the data input device is further adapted to update an existing database record in the location database.

8. The system of claim 1, wherein the output device includes at least one of a computing device, a portable computing device, a printing device, a cellular telephone, a personal digital assistant, a smartphone and a portable wireless device.

9. The system of claim 1, wherein the data management tool is a software application.

10. The system of claim 1, wherein the data management tool is accessible via at least one of a network portal, an intranet and the Internet.

11. The system of claim 1, wherein the data operations include at least one of viewing, editing, copying, moving, transmitting and deleting the at least one database record.

12. The system of claim 1, wherein the location database is located within the sales environment.

13. The system of claim 1, wherein the location database is located on a network outside of the sales environment.

14. The system of claim 1, wherein the merchandise location information is accessible in real-time.

15. The system of claim 1, further comprising a mapping component for mapping merchandise location information in an Enterprise Resource Planning system.

16. A computer-implemented merchandise location system, comprising:
a location recording device for recording merchandise location information within a sales environment;
a location database adapted to store merchandise location information;
a data input device for creating at least one database record in the location database;
an output device adapted to output the at least one database record;
a data management tool adapted to receive a request from an authorized user and, in response to the request, transmit the at least one database record to the output device; and
a compliance mechanism adapted to review the merchandise location information and notify the user when the merchandise location information is not in accordance with a predetermined agreement;
wherein the data management tool allows the authorized user to perform data operations on the at least one database record;
and wherein the data management tool allows more than one authorized user simultaneous access to the at least one database record; and
wherein the compliance mechanism is further adapted to generate a compliance report at a predetermined time interval.

17. The system of claim 16, wherein the merchandise location information is determined, at least in part, using at least one of a barcode technology, a Radio Frequency Identification technology and a triangulation technology.

18. The system of claim 16, wherein the data management tool associates merchandise location information with merchandise sales information within the sales environment.

19. The system of claim 18, wherein the merchandise sales information is located in a third party vendor database.

20. A computer-implemented merchandise location system, comprising:
a location recording device for recording merchandise location information within a store;
a location database adapted to store merchandise location information;
a data input device for creating at least one database record in the location database;
an output device adapted to output the at least one database record; and
a data management tool operating on a networked computing device, the data management tool adapted to receive a request from an authorized user and, in response to the request, transmit the at least one database record to the output device;
wherein the data management tool allows the authorized user to perform data operations on the at least one database record;
and wherein the data management tool allows more than one authorized user simultaneous access to the at least one database record.
